(19) United States
(12) Patent Application Publication
(10) Pub. No.: US 2021/0241273 A1
(43) Pub. Date: Aug. 5, 2021

(54) SMART CONTRACT PLATFORM

(71) Applicant: Capital One Services, LLC, McLean, VA (US)

(72) Inventors: Fardin Abdi Taghi ABAD, Champaign, IL (US); Jeremy GOODSITT, Champaign, IL (US); Reza FARIVAR, Champaign, IL (US); Austin WALTERS, Savoy, IL (US); Mark WATSON, Urbana, IL (US); Kenneth TAYLOR, Champaign, IL (US); Kate KEY, Effingham, IL (US); Anh TRUONG, Champaign, IL (US); Vincent PHAM, Champaign, IL (US)

(21) Appl. No.: 16/779,504

(22) Filed: Jan. 31, 2020

(51) Int. Cl. G06Q 20/40; H04L 9/06; G06N 20/00

(52) U.S. Cl. CPC G06Q 20/405; G06N 20/00; H04L 9/0637

(57) ABSTRACT

A device may receive information related to a smart contract to be generated by the device, wherein the information is associated with a set of functions to be included in the smart contract. The device may identify one or more candidate code snippets corresponding to respective ones of the set of functions to be included in the smart contract, wherein the device identifies the one or more candidate code snippets from a plurality of code snippets stored in a blockchain. The device may determine respective quality indications of the one or more candidate code snippets. The device may select, based on the respective quality indications, a set of one or more code snippets, of the one or more candidate code snippets, corresponding to the set of functions. The device may generate the smart contract using the selected set of one or more code snippets corresponding to the set of functions.

### BACKGROUND

A smart contract is a computer protocol intended to digitally facilitate, verify, or enforce a contract. Smart contracts allow performance of credible transactions without third parties. Such transactions may be trackable and irreversible. A smart contract may be stored in a blockchain. A blockchain is a distributed database that maintains a continuously-growing list of records, called blocks, that may be linked together to form a chain. Each block in the blockchain may contain a timestamp and a link to a previous block and/or transaction. The blocks may be secured from tampering and revision. In addition, a blockchain may include a secure transaction ledger database shared by parties participating in an established, distributed network of computers. A blockchain may record a transaction (e.g., an exchange or transfer of information) that occurs in the network, thereby reducing or eliminating the need for trusted/centralized third parties. In some cases, the parties participating in a transaction may not know the identities of any other parties participating in the transaction but may securely exchange information. Further, the distributed ledger may correspond to a record of consensus with a cryptographic audit trail that is maintained and validated by a set of independent computers.

### SUMMARY

According to some implementations, a method may include receiving, by a device, information related to a smart contract to be generated by the device, wherein the information is associated with a set of functions to be included in the smart contract; identifying, by the device, one or more candidate code snippets corresponding to respective ones of the set of functions to be included in the smart contract, wherein the device identifies the one or more candidate code snippets from a plurality of code snippets stored in a blockchain; determining, by the device, respective quality indications of the one or more candidate code snippets; selecting, by the device and based on the respective quality indications, a set of one or more code snippets, of the one or more candidate code snippets, corresponding to the set of functions; generating, by the device, the smart contract using the selected set of one or more code snippets corresponding to the set of functions; and performing, by the device and after generating the smart contract, a set of tests of the smart contract, wherein the set of tests is associated with testing the smart contract based on satisfaction of the set of functions to be included in the smart contract.

According to some implementations, a device may include one or more memories; and one or more processors, communicatively coupled to the one or more memories, configured to: receive, from a client device, information related to a smart contract to be generated by the device, wherein the information is associated with a set of functions to be included in the smart contract; identify one or more candidate code snippets corresponding to respective ones of the set of functions to be included in the smart contract, wherein the device is to identify the one or more candidate code snippets from a plurality of code snippets stored in a blockchain; determine respective quality indications of the one or more candidate code snippets; provide, to the client device, identifications of the one or more candidate code snippets and the respective quality indications; receive, from the client device, a selection of a set of one or more code snippets of the one or more candidate code snippets; generate the smart contract using the selected set of one or more code snippets; and perform, after generating the smart contract, a set of tests of the smart contract, wherein the set of tests is associated with testing the smart contract based on satisfaction of the set of functions to be included in the smart contract.

According to some implementations, a non-transitory computer-readable medium may store one or more instructions. The one or more instructions, when executed by one or more processors of a device, may cause the one or more processors to: receive information related to a smart contract to be generated, wherein the information is associated with a set of functions to be included in the smart contract; identify one or more candidate code snippets, from a plurality of code snippets stored in a blockchain, corresponding to respective ones of the set of functions to be included in the smart contract; select, from the one or more candidate code snippets, a set of one or more code snippets corresponding to the set of functions; wherein the selection of the set of one or more code snippets is based on respective quality indications of the one or more candidate code snippets; generate the smart contract using the set of one or more code snippets corresponding to the set of functions; perform, after generating the smart contract, a set of tests of the smart contract, wherein the set of tests is associated with testing the smart contract based on satisfaction of the set of functions to be included in the smart contract; and perform one or more actions based on a result of the set of tests of the smart contract.

### BRIEF DESCRIPTION OF THE DRAWINGS

FIGS. 1A-1E are diagrams of one or more example implementations described herein.

FIG. 2 is a diagram of an example environment in which systems and/or methods described herein may be implemented.

FIG. 3 is a diagram of example components of one or more devices of FIG. 2.

FIG. 4 is a flow chart of an example process for generating a smart contract.

FIG. 5 is a flow chart of an example process for generating a smart contract.

FIG. 6 is a flow chart of an example process for generating a smart contract.

### DETAILED DESCRIPTION

The following detailed description of example implementations refers to the accompanying drawings. The same reference numbers in different drawings may identify the same or similar elements.

Parties to an agreement may elect to use a smart contract to digitally facilitate, verify, or enforce the agreement. A smart contract may include functions that can be carried out automatically using computing resources (e.g., processor resources, memory resources, communication resources, and/or the like) without input from a user. The smart contract may be stored in a blockchain. Blockchain storage may secure the smart contract from tampering and revision, which may provide improved security compared with a smart contract stored with a device associated with a party of the contract or a third party device.

It can be difficult to generate a smart contract that functions as intended. An error in coding of the smart contract can cause a failure to perform one or more functions of the smart contract. For example, the error may cause a failure to transfer money from an account of one party of the contract to an account of another party of the contract. In an attempt to avoid errors in the smart contract, parties may consume significant computing resources to generate and test a smart contract before use. As a result, a cost of generating and testing the smart contract may be prohibitive.

According to some implementations described herein, parties may use a smart contract platform to generate a smart contract using one or more code snippets. In some implementations, the smart contract platform may receive, from a device associated with one or more entities intending to be parties in a smart contract, information related to functions to be included in the smart contract. In some implementations, the smart contract platform selects code snippets that have already been written, corresponding to the functions, to include in the smart contract. In this way, computing resources may be conserved, which may otherwise have been used to write new code snippets corresponding to the functions.

In some implementations, the smart contract platform selects the code snippets, from candidate code snippets available for use in a smart contract, based on the information received by the smart contract platform and quality indications of the candidate code snippets. For example, the smart contract platform may select, based on the quality indications, a code snippet for a function to be included in the smart contract, as identified in the received information. In this way, computing resources may be conserved, which would otherwise have been used to generate new code snippets for respective functions to be included in the smart contract. Additionally, computing resources may be conserved, which would otherwise have been used to test new code snippets, or find and test multiple candidate code snippets, for errors. Further, computing resources may be conserved, which otherwise would have been used to recover from an error in the smart contract.

In some implementations, the smart contract platform may provide, to a client device, identifications of candidate code snippets available for use in the smart contract. The smart contract platform may also provide, to the client device, quality indications associated with the identifications of the candidate code snippets. In some implementations, the smart contract platform may receive a selection of candidate code snippets from the client device. The smart contract platform may then select, for inclusion in the smart contract, the candidate code snippets identified in the selection of the client device. In this way, computing resources may be conserved, which otherwise would have been used to generate new code snippets. Additionally, computing resources may be conserved, which otherwise would have been used to find and test multiple candidate code snippets.

The smart contract platform may then generate the smart contract using the selected code snippets. The smart contract may also include wrapper code and/or one or more connectors. In this way, one or more distinct code snippets, which may originate from different sources, may be combined into a single code document with an improved likelihood of successfully performing the functions. This may conserve computing resources, which otherwise may have been used to recover from an error in the smart contract. Additionally, this may conserve computing resources, which otherwise may have been used to troubleshoot an error in the smart contract that is detected via testing before implementation of the smart contract.

In some implementations, the smart contract platform may perform a set of tests on the smart contract to determine if the functions, to be included in the contract, perform as desired. Based on the result of the set of tests, the smart contract platform may perform one or more actions.

In some implementations, based on one or more tests of the set of tests resulting in a failure, the smart contract platform may perform one or more actions to replace one or more of the code snippets of the smart contract. In some implementations, the smart contract platform may identify a code snippet that caused one or more of the set of tests to result in a failure. In some implementations, the smart contract platform may automatically, and without additional input from a user, select another candidate code snippet to replace one or more of the code snippets of the smart contract. The smart contract platform may select the other candidate snippet based on the quality indications of the candidate code snippets. In this way, computing resources may be conserved, which otherwise may have been used to communicate the result of the set of tests and to receive further instruction from a user. Additionally, computing resources may be conserved, which otherwise may have been used to find, without indications of quality, and test multiple candidate replacement code snippets.

In some implementations, the smart contract platform may provide identifications of candidate replacement code snippets to the client device for selection of a replacement code snippet. In this way, computing resources may be conserved, which otherwise may have been used to find, without indications of quality, and test multiple candidate replacement code snippets.

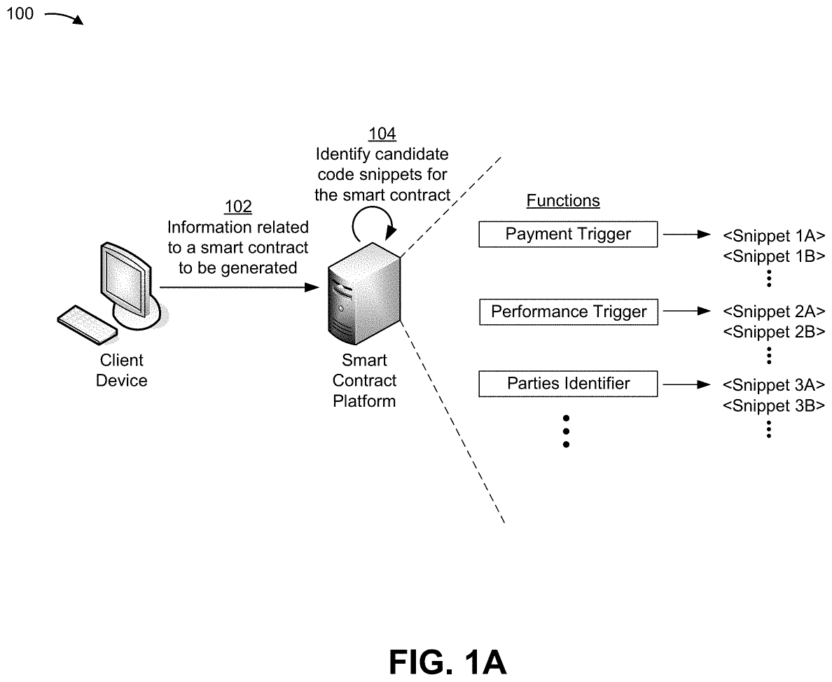

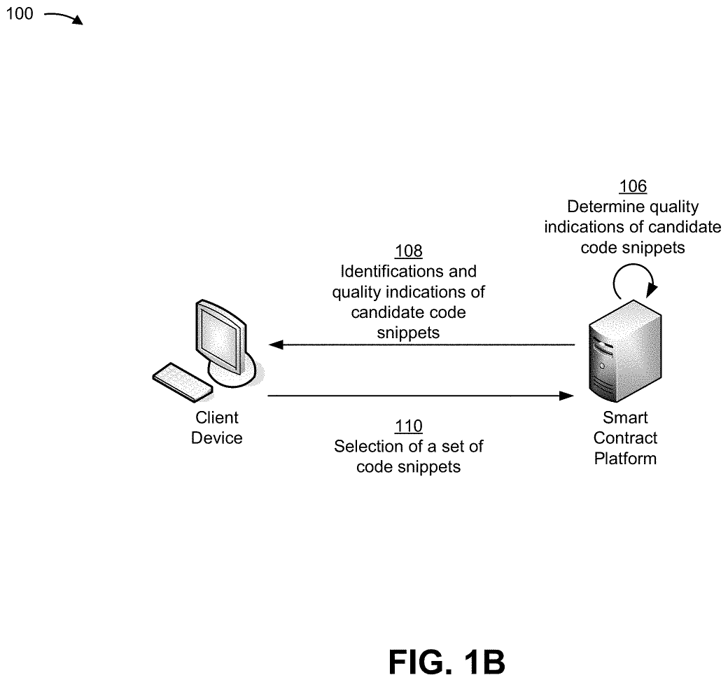

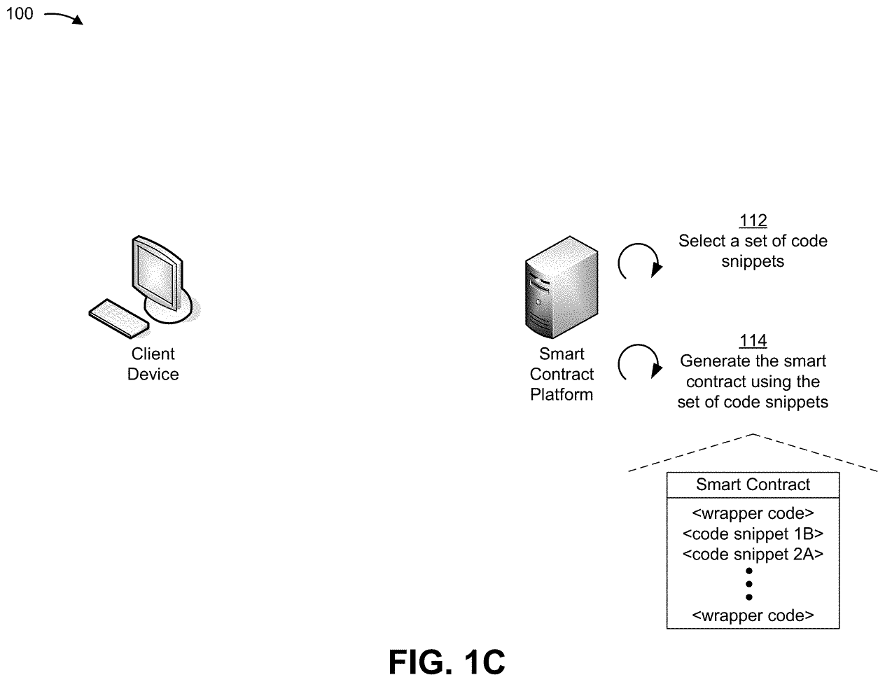

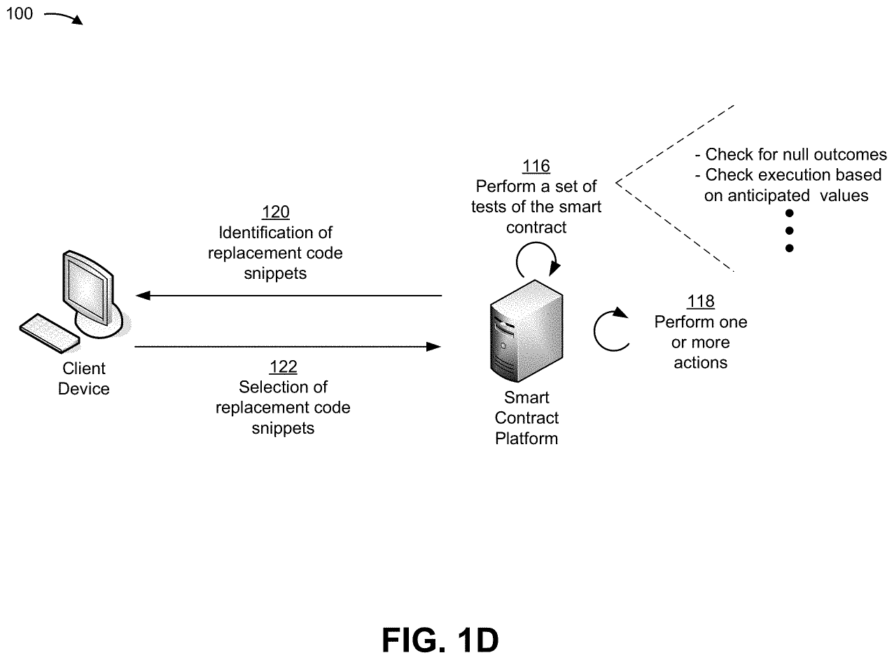

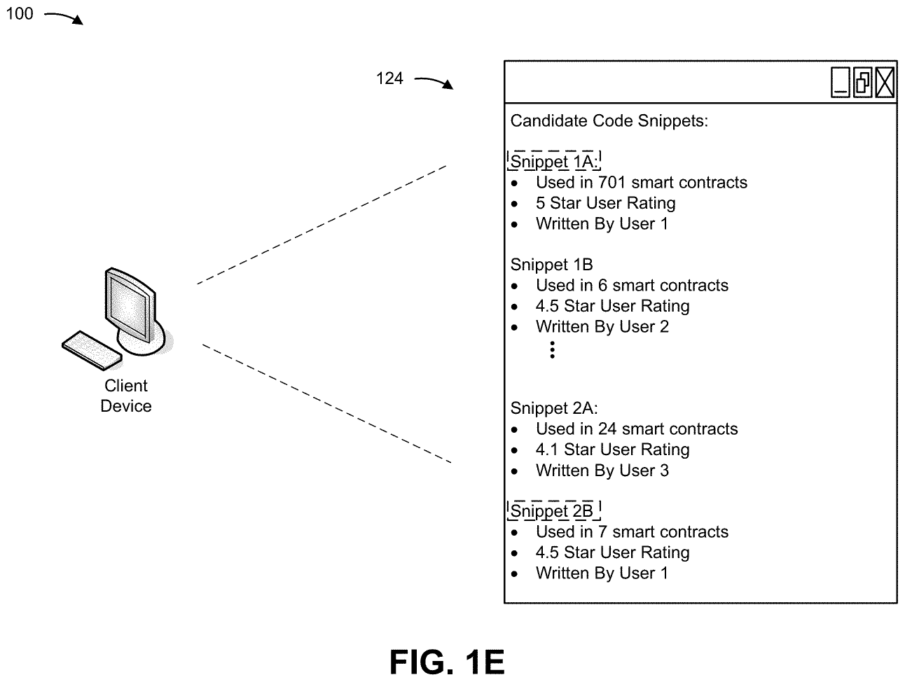

FIGS. 1A-1E are diagrams of one or more example implementations 100 described herein. As shown in FIGS. 1A-1E, the example implementation(s) 100 may include a client device and a smart contract platform. In some implementations, the client device is associated with a party to a smart contract to be generated by the smart contract platform. For example, the client device may be associated with an employee, agent, legal representative, and/or the like of the party to the smart contract to be generated by the smart contract platform.

As shown in FIG. 1A, and by reference number 102, the smart contract platform may receive, from the client device, information related to a smart contract to be generated. In some implementations, the information may be associated with a set of functions to be included in the smart contract to be generated.

In some implementations, the set of functions may correspond to one or more actions to be performed by the smart contract. For example, an action may include initiating a payment, transferring property, sending an instruction and/or a command to perform a task to another device, and/or the like. In some implementations, a function may correspond to a trigger to initiate a payment, a trigger to initiate sending a command to another device, an identity of one or more parties to the smart contract, a transaction account identifier, and/or the like.

In some implementations, a function may define a trigger to initiate sending a command to a device associated with an account entity (e.g., a financial institution). The trigger may be based on a condition being satisfied, such as satisfaction of a timing condition or satisfaction of a performance condition. The command may include an instruction and authorization to transfer funds from an account associated with a transaction account identifier to an account associated with another transaction account identifier. In this way, terms of the smart contract may be performed automatically. Additionally, computing resources may be conserved, which otherwise may have been used to request performance, follow up with requests of performance, and/or recover from failure to perform according to terms of the smart contract.

In some implementations, the information, received by the smart contract platform, may include identifications of conditions for performing actions according to the smart contract. In some implementations, a condition is associated with one or more of the functions to be included in the smart contract. In some implementations, the condition may identify a date at which a function of the smart contract triggers an action. For example, a transfer of title to property may be triggered on a specified date. In some implementations, the condition may identify a first action as a condition for performing a second action. For example, a transfer of title to property may be conditional on payment in full of a loan amount. In some implementations, the condition may include a combination of sub-conditions for performing an action. For example, a transfer of title to property may be triggered on a specified date only if a transferring party has received each scheduled payment of a loan from the receiving party.

In some implementations, the client device may initiate a smart contract generation action with the smart contract platform. For example, the client device may initiate a contract generation process within an application local to the client device, an interactive webpage, and/or the like. In some implementations, the smart contract platform may provide, to the client device, a set of identifications and/or descriptions corresponding to a set of candidate functions for presentation via a display via the client device. The client device may receive input to select one or more of the candidate functions. The client device may provide, to the smart contract platform as information related to the smart contract to be generated, one or more indications of the one or more selections.

In some implementations, the information, received by the smart contract platform, may include natural language descriptions of one or more functions to be included in the smart contract. For example, the information may include a written contract. In other examples, the information may include natural language descriptions of one or more sections of an agreement, such as one or more triggers and/or conditions for performing actions. In some implementations, the smart contract platform may associate the information related to the smart contract with a set of functions to be included in the smart contract. In some implementations, the smart contract platform may apply a model generated via a machine learning process, to the received information, to associate the set of functions with the received information.

As described herein, the smart contract platform may use one or more artificial intelligence techniques, such as machine learning, deep learning, and/or the like to determine an association of a function with a portion of natural language in information provided to the smart contract platform.

In some implementations, the smart contract platform may parse natural language contained in information provided to the smart contract platform to determine one or more functions associated with portions of natural language in the information. For example, the smart contract platform may identify, within the information and in natural language, a description of a function to be included in the smart contract, and may parse the data to identify parameters associated with the function.

In some implementations, the smart contract platform may determine that the information describes one or more characteristics of a function, which characteristics may include one or more actions, one or more conditions for initiating the one or more actions, identification of one or more parties, identification of one or more transaction accounts, identification of one or more properties, and/or the like. For example, the information may include, in natural language, “Party A agrees to transfer title to Property 1 to Party B on Jul. 21, 2031, so long as Party A has received $30,000 in total monthly payments, into Transaction Account 123, from Party B before Jul. 20, 2031”. The smart contract platform may use natural language processing to determine that characteristics of the function include 1) an action to transfer a title document 2) the transfer of title is conditional on Party A receiving $30,000, 3) Party A is to transfer the title document to Party B, 4) the receiving transaction account is identified by “123,” and 5) the title document is associated with Property 1. In this case, the smart contract platform may determine that a natural language text corresponds to characteristics of the function based on identifying key words, phrases, character sequences, capitalized letters, and/or the like within the information. In some implementations, the smart contract platform may determine that a natural language text corresponds to characteristics of the function based on relationships among words, phrases, character sequences, and/or the like within the information. In this way, the smart contract platform may identify a function, and/or characteristics of the function, within the information.

Based on applying a rigorous and automated process associated with identifying functions, and/or characteristics of the functions, the smart contract platform enables recognition and/or identification of thousands or millions of parameters associated with identifying functions, and or characteristics of the functions, for thousands or millions of natural language combinations of words, phrases, character sequences, and/or the like. This may increase an accuracy and consistency of identifying a function, and/or characteristics of the function, relative to requiring computing resources to be allocated for hundreds or thousands of technicians to manually identify a function, and/or characteristics of the function, within the thousands or millions of combinations of words, phrases, character sequences, and/or the like of information as provided in hundreds or thousands of requests to generate smart contracts based on natural language.

In some implementations, the smart contract platform may determine whether the natural language of the information includes, or is likely to include, a description of a function to be included in the smart contract, as described herein. For example, analyzing words, phrases, character sequences, and/or the like, the smart contract platform may determine whether the natural language of the information includes, or is likely to include, a description of a function to be included in the smart contract. In this case, the smart contract platform may train an information scanning model. For example, the smart contract platform may train the information scanning model using information that includes words, phrases, character sequences, and/or the like, to identify a description of a function to be included in the smart contracts. As an example, the smart contract platform may determine that historical words, phrases, character sequences, and/or the like are associated with a threshold probability of being associated with a description of a function to be included in the smart contract. In some implementations, the smart contract platform may use a scoring system (e.g., with relatively high scores and/or relatively low scores) to identify and/or classify natural language of information as being associated with a description of a function to be included in the smart contract. In this case, the smart contract platform may determine that a relatively high score (e.g., as being likely to include a description of a function) is to be assigned to words, phrases, character sequences, and/or the like that are determined to be the same or similar as previously identified words, phrases, character sequences, and/or the like of a description of a function to be included in the smart contracts (or more frequently determined to include a description of a function than past identified words, phrases, character sequences, and/or the like). In contrast, the smart contract platform may determine that a relatively low score (e.g., as being unlikely to be include a description of a function) is to be assigned to words, phrases, character sequences, and/or the like that are determined to be different than past identified words, phrases, character sequences, and/or the like of a description of a function to be included in the smart contracts (or less frequently identified than past identified words, phrases, character sequences, and/or the like).

In some implementations, the smart contract platform may perform a data preprocessing operation when generating the information scanning model. For example, the smart contract platform may preprocess data (e.g., natural language of information from one or more requests to generate a smart contract and/or the like) to remove non-ASCII characters, white spaces, and/or the like. In this way, the smart contract platform may organize thousands, millions, or billions of data points for machine learning and model generation.

In some implementations, the smart contract platform may perform a training operation when generating the information scanning model. For example, the smart contract platform may portion received information relating to words, phrases, character sequences, and/or the like into a training set (e.g., a set of data to train the information scanning model), a validation set (e.g., a set of data used to evaluate a fit of the information scanning model and/or to fine tune the information scanning model), a test set (e.g., a set of data used to evaluate a final fit of the information scanning model), and/or the like. In some implementations, the smart contract platform may preprocess and/or perform dimensionality reduction to reduce information relating to words, phrases, character sequences, and/or the like to a minimum feature set. In some implementations, the smart contract platform may train the information scanning model on this minimum feature set, thereby reducing processing to train the machine learning model, and may apply a classification technique, to the minimum feature set.

In some implementations, the smart contract platform may use a classification technique, such as a logistic regression classification technique, a random forest classification technique, a gradient boosting machine learning (GBM) technique, and/or the like, to determine a categorical outcome (e.g., that natural language of the information includes a description of a function to be included in the smart contract, that natural language of the information does not include a description of a function to be included in the smart contract, and/or the like). Additionally, or alternatively, the smart contract platform may use a naïve Bayesian classifier technique. In this case, the smart contract platform may perform binary recursive partitioning to split the data of the minimum feature set into partitions and/or branches and use the partitions and/or branches to perform predictions (e.g., that natural language of the information does or does not include a description of a function to be included in the smart contract). Based on using recursive partitioning, the smart contract platform may reduce utilization of computing resources relative to manual, linear sorting and analysis of data points, thereby enabling use of thousands, millions, or billions of data points to train a model, which may result in a more accurate model than using fewer data points.

Additionally, or alternatively, the smart contract platform may use a support vector machine (SVM) classifier technique to generate a non-linear boundary between data points in the training set. In this case, the non-linear boundary is used to classify test data (e.g., natural language of information within a request to generate a smart contract) into a particular class (e.g., a class indicating that the information includes a description of a function to be included in the smart contract, a class indicating that the content does not include a description of a function to be included in the smart contract, and/or the like).

Additionally, or alternatively, where the test data includes image data, video data, and/or the like, the smart contract platform may use a computer vision technique, such as a convolutional neural network technique to assist in classifying test data (e.g., data relating to natural language of the information) into a particular class (e.g., a class indicating that the natural language of the information includes a description of a function to be included in the smart contract, a class indicating that the natural language of the information does not include a description of a function to be included in the smart contract, and/or the like). In some cases, the computer vision technique may include using an image recognition technique (e.g., an Inception framework, a ResNet framework, a Visual Geometry Group (VGG) framework, and/or the like), and/or the like.

Additionally, or alternatively, the smart contract platform may train the information scanning model using a supervised training procedure that includes receiving input to the information scanning model from a subject matter expert, which may reduce an amount of time, an amount of processing resources, and/or the like to train the information scanning model relative to an unsupervised training procedure. In some implementations, the smart contract platform may use one or more other model training techniques, such as a neural network technique, a latent semantic indexing technique, and/or the like. For example, the smart contract platform may perform an artificial neural network processing technique (e.g., using a two-layer feedforward neural network architecture, a three-layer feedforward neural network architecture, and/or the like) to perform pattern recognition with regard to patterns of whether natural language of the information includes a description of a function to be included in the smart contract described using different semantic descriptions or not. In this case, using the artificial neural network processing technique may improve an accuracy of a model (e.g., information scanning model) generated by the smart contract platform by being more robust to noisy, imprecise, or incomplete data, and by enabling the smart contract platform to detect patterns and/or trends undetectable to human analysts or systems using less complex techniques.

As an example, the smart contract platform may use a supervised multi-label classification technique to train the information scanning model. For example, as a first step, the smart contract platform may map words, phrases, character sequences, and/or the like to a description of a function to be included in the smart contract. In this case, the words, phrases, character sequences, and/or the like may be characterized as being a description of a function to be included in the smart contract or not based on characteristics of the words, phrases, character sequences, and/or the like (e.g., whether a characteristic of a word, phrase, character sequence, and/or the like is similar or associated with a word, phrase, character sequence, and/or the like that includes a description of a function to be included in the smart contract) and an analysis of the word, phrase, character sequence, and/or the like (e.g., by a technician, thereby reducing processing relative to the smart contract platform being required to analyze each activity). As a second step, the smart contract platform may determine classifier chains, whereby labels of target variables may be correlated (e.g., in this example, labels may be words, phrases, character sequences, and/or the like and correlation may refer to a common characteristic of a word, phrase, character sequence, and/or the like that includes a description of a function to be included in the smart contract). In this case, the smart contract platform may use an output of a first label as an input for a second label (as well as one or more input features, which may be other data relating to the natural language of the information), and may determine a likelihood that particular natural language of the information that includes a set of characteristics (some of which are associated with a particular description of a function and some of which are not associated with the particular description of the function) are associated with the particular description of the function based on a similarity to a word, phrase, character sequence, and/or the like that include similar characteristics. In this way, the smart contract platform transforms classification from a multi-label classification problem to multiple single-classification problems, thereby reducing processing utilization.

As a third step, the smart contract platform may determine a Hamming Loss Metric relating to an accuracy of a label in performing a classification by using the validation set of the data. For example, an accuracy with which a weighting applied to each word, phrase, character sequence, and/or the like and whether each word, phrase, character sequence, and/or the like is associated with a description of a function to be included in the smart contract or not, results in a correct prediction of whether natural language of the information includes a description of a function to be included in the smart contract, thereby accounting for differing amounts to which association of any one word, phrase, character sequence, and/or the like influences a determination of whether natural language of the information includes and description of a function to be included in the smart contract.

As a fourth step, the smart contract platform may finalize the information scanning model based on labels that satisfy a threshold accuracy associated with the Hamming Loss Metric and may use the information scanning model for subsequent prediction of whether natural language of the information includes a description of a function to be included in the smart contract.

As another example, the smart contract platform may determine, using a linear regression technique, that a threshold percentage of words, phrases, character sequences, and/or the like, in natural language of a set of information for requests to generate smart contracts, do not include a description of a function to be included in the smart contract, and may determine that those words, phrases, character sequences, and/or the like are to receive relatively low association scores. In contrast, the smart contract platform may determine that another threshold percentage of words, phrases, character sequences, and/or the like, in natural language of a set of information for requests to generate smart contracts, do include a description of a function to be included in the smart contract, and may assign a relatively high association score to those words, phrases, character sequences, and/or the like. Based on the characteristics of words, phrases, character sequences, and/or the like including a description of a function to be included in the smart contract or not, the smart contract platform may train the information scanning model and may use the information scanning model for analyzing new words, phrases, character sequences, and/or the like that the smart contract platform identifies.

In some implementations, a different device, such as a server device, may generate and train the information scanning model. The different device may send the information scanning model for use by the smart contract platform. The different device may update and send (e.g., on a scheduled basis, on an on-demand basis, on a triggered basis, on a periodic basis, and/or the like) the information scanning model to the smart contract platform.

Accordingly, the smart contract platform may use any number of artificial intelligence techniques, machine learning techniques, deep learning techniques, and/or the like to determine whether natural language of the information includes a description of a function to be included in the smart contract.

As shown by reference number 104, the smart contract platform may identify one or more candidate code snippets for the smart contract. The one or more candidate code snippets may correspond to respective functions of the set of functions associated with the information received by the smart contract platform. In some implementations, the smart contract platform may identify one or more candidate code snippets for each one of the set of functions associated with the information received by the smart contract platform.

The smart contract platform may identify the one or more candidate code snippets from one or more catalogues of candidate code snippets that are available to use in the smart contract. In some implementations, the one or more candidate code snippets and/or the one or more catalogues may be stored in a blockchain. In some implementations, the one or more candidate code snippets and/or the one or more catalogues may be stored in a storage component associated with, or accessible to, the smart contract platform. In these implementations, computing resources may be conserved, which otherwise may have been used to test for, and/or recover from, tampering of the one or more code snippets or the catalogue by a third party.

In some implementations, the smart contract platform may maintain, or have access to, a catalogue of candidate code snippets and corresponding functions. The catalogue may include descriptions of candidate code snippets, descriptions of corresponding functions, locations of candidate code snippets, instructions for retrieving candidate code snippets, quality indications of candidate code snippets, and/or the like. In this way, the information in the catalogue is accessible to the smart contract platform and computing resources may be conserved, which otherwise may have been used to locate and request the information in the catalogue from one or more devices.

As shown in FIG. 1B, and by reference number 106, the smart contract platform may determine quality indications of candidate code snippets. In some implementations, a quality indication for a candidate code snippet is based on an indication of a source of the candidate code snippet, a quality rating of the source of the candidate code snippet, an indication of a quantity of other smart contracts that currently use or previously used the candidate code snippet, a quality rating of the code snippet that is based on current or previous use of the code snippet, and/or the like. In some implementations, a candidate code snippet may be associated with multiple quality indications. In some implementations, a candidate code snippet may be associated with a composite score of multiple quality indications.

In this way, the smart contract platform may determine indications of quality of candidate code snippets without consuming computing resources by testing each of the candidate code snippets. Additionally, computing resources may also be conserved, which otherwise may have been used to iteratively generate a smart contract with code snippets having unproven qualities, test the code snippets, and then replace failing code snippets with replacement code snippets that also have unproven qualities.

As shown by reference number 108, the smart contract platform may provide, to the client device, the identifications of the candidate code snippets along with the quality indications. In some implementations, the smart contract platform may provide, to the client device, identifications and associated quality indications for each of the candidate code snippets.

As shown by reference number 110, the smart contract platform may receive, from the client device, a selection of a set of one or more code snippets of the candidate code snippets. Thus, the smart contract platform determines indications of quality of candidate code snippets and allows a user to select one or more of the candidate code snippets to include in the smart contract. In this way, computer resources may be conserved, which otherwise may have been used to manually search for and select code snippets having unproven qualities, test the code snippets, and then replace failing code snippets with replacement code snippets that also have unproven qualities.

As shown in FIG. 1C, and by reference number 112, the smart contract platform may select a set of code snippets corresponding to the set of functions associated with the information received from the client device. The smart contract platform may select the set of code snippets, from the candidate code snippets, based on respective quality indications of the candidate code snippets. In some implementations, the smart contract platform may associate a score with one or more types of quality indications. The smart contract platform may select, for each of the functions, the candidate code snippet having a highest score. In some implementations, the smart contract platform may filter candidate code snippets using a minimum score threshold for one more of the quality indications. The smart contract platform may then select the candidate code snippet having a highest score for one or more of the quality indications. For example, the smart contract platform may filter out all candidate code snippets that have been used in fewer than a threshold quantity of smart contracts and/or filter out all candidate code snippets that have been written by a programmer having a reliability score that is less than a threshold, and then select the candidate code snipped based on a highest user rating of the remaining unfiltered candidate conde snippets. In this way, computing resources may be conserved, which otherwise may have been used to develop and write one or more code snippets corresponding to the set of functions associated with the information received from the client device.

In some implementations, the smart contract platform may select the set of code snippets, from the candidate code snippets, based on the selection of the set of one or more code snippets received from the client device.

In some implementations, the smart contract platform selects the set of code snippets based further on results of verifying an authenticity of the candidate code snippets. For example, one or more of the candidate code snippets may be provisionally selected, based on respective quality indications and/or a selection received from the client device, before a verification process is performed on only those that are provisionally selected. In some implementations, the smart contract platform may perform a verification process on each of the one or more of the candidate code snippets or some subset of the candidate code snippets.

The verification process may include determining a hash of a candidate code snippet and comparing the hash with a hash of an authentic code snippet. For example, the hash of the authentic code snippet may be associated with the quality indications, and may be publicly known. Thus, the candidate code snippets can be verified as authentic code snippets that are associated with the quality indications. In this way, the smart contract platform may determine a measure of quality of a candidate code snippet by verifying that the candidate code snippet is authentic, and then relying on one or more quality indications associated with the authentic candidate code snippet. This technique of determining a measure of quality of a candidate code snippet may conserve computing resources that may otherwise be used to determine measures of quality of the candidate code snippets via testing each candidate code snippet.

As shown by reference number 114, the smart contract platform may generate the smart contract using the selected set of code snippets. In some implementations, the smart contract platform may combine the set of code snippets into a code document. In some implementations, the set code snippets may be combined in an order in which the set is to be executed upon satisfaction of one or more conditions. In this way, the set of code snippets may have an increased likelihood of correctly performing the corresponding functions of the smart contract. This may conserve computing resources that may otherwise be used to troubleshoot or recover from a failure of the smart contract.

When generating the smart contract, the smart contract platform may include wrapper code with the set of code snippets. The wrapper code may include code to support interactions between individual code snippets of the set. In some implementations, the wrapper code may provide one or more interfaces between the individual code snippets of the set. In this way, the set of code snippets may have an increased likelihood of correctly performing the corresponding functions of the smart contract. This may conserve computing resources that may otherwise be used to troubleshoot or recover from a failure of the smart contract.

As shown in FIG. 1D, and by reference number 116, the smart contract platform may perform a set of tests on the smart contract. In some implementations, the set of tests is associated with testing the smart contract based on satisfaction of the set of functions associated with the information received from the client device. For example, the set of tests may check if execution of one or more code snippets of the set of code snippets results in an anticipated value or result. In some implementations, the set of tests is associated with testing for null outcomes upon execution of one or more code snippets of the set of code snippets.

As shown by reference number 118, the smart contract platform may perform one or more actions. In some implementations, the smart contract platform may perform the one or more actions based on one or more results of the set of tests of the smart contract. In some implementations, the one or more actions may include determining one or more causes of the result of the set of tests of the smart contract. In this way, computing resources may be conserved by identifying a code snippet that needs replacing, rather than using computing resources to code an entirely new smart contract or to identify a new set of code snippets to generate a new smart contract.

In some implementations, the smart contract platform may store the smart contract in the blockchain. In some implementations, storing the smart contract in the blockchain may prevent tampering of the contract after storing the smart contract in the blockchain. In some implementations, the smart contract platform may execute the code of the smart contract to perform the terms of the smart contract.

In some implementations, the smart contract platform may detect satisfaction of one or more conditions associated with the smart contract (e.g., associated with a code snippet of the set of code snippets). Based on the satisfaction of the one or more conditions, the smart contract may then perform one or more actions defined by the smart contract.

In some implementations, the smart contract platform may select one or more replacement code snippets for one or more code snippets of the set of code snippets. In some implementations, the smart contract platform may select one or more replacement code snippets based on a result of one or more tests of the set of tests of the smart contract. For example, the one or more tests may identify one or more code snippets, of the set of code snippets, that caused a failure of one or more tests. The smart contract platform may then identify one or more candidate code snippets as candidates for replacing the one or more code snippets identified as causing the failure of one or more tests. In some implementations, the smart contract platform may select one or more candidate code snippets (e.g., based on quality indications) to replace the one or more code snippets identified as causing the failure of one or more tests. The smart contract platform may then replace the one or more code snippets identified as causing the failure of one or more tests automatically and without further user input.

As shown by reference number 120, the smart contract platform may provide, to the client device, identification of one or more replacement code snippets. The smart contract platform may also provide quality indications of the one or more replacement code snippets. In some implementations, the one or more replacement code snippets may correspond to one or more code snippets identified as causing failure of one or more tests of the smart contract. The client device may select, or receive input selecting, one or more of the one or more replacement code snippets to replace one or more of the code snippets of the set of code snippets.

As shown by reference number 122, the smart contract platform may receive a selection of a set of code snippets from the client device. The smart contract platform may then replace one or more code snippets of the set of code snippets with the selected one or more of the one or more replacement code snippets.

By performing a set of tests of the smart contract, according to the techniques disclosed herein, computing resources may be conserved by detecting failures of the smart contract prior to storing the smart contract in the blockchain, where making revisions may use substantial computing resources.

As shown in FIG. 1E, the smart contract platform may provide, to the client device for presentation via a display of the client device or another associated device, identifications and quality indications of candidate code snippets. In some implementations, the candidate code snippets are organized by respective functions to which the candidate code snippets correspond. For example, candidate code snippets relating to payment triggers may be grouped such that a user of the client device may choose one of the candidate code snippets relating to payment triggers. Similarly, candidate code snippets relating to performance triggers may be grouped together.

In some implementations, one or more quality indications of a candidate code snippet may include information that may be useful to determine a likelihood of successful execution of the candidate code snippet. In some implementations, the one or more quality indications of a candidate code snippet may include an indication of a quantity of other smart contracts that currently use or have used the candidate code snippet, and quality rating of the candidate code snippet based on prior or current use of the candidate code snippet, an indication of a source (e.g., author, storage location, and/or the like) of the candidate code snippet, and/or the like. The quality rating may include, or be based on, feedback from parties to smart contracts that include or included the candidate code snippet. In some implementations, the quality rating includes, or is based on, indications by a smart contract generating device regarding successful and/or unsuccessful implementation of the candidate code snippet into a smart contract.

Using the techniques describes herein, a smart contract may be generated using candidate code snippets based on quality indications of the candidate code snippets. This may provide a user-friendly process for generating smart contracts while conserving computing resources, that may otherwise be used to write new code snippets corresponding to each of the functions to be included in the smart contract. Additionally, the techniques described herein may improve reliability of a smart contract based on using components that have been previously tested and/or rated for performance. This may reduce computing resources that may otherwise be used to recover from a failure of a smart contract.

As indicated above, FIGS. 1A-1E are provided as one or more examples. Other examples may differ from what is described with regard to FIGS. 1A-1E.

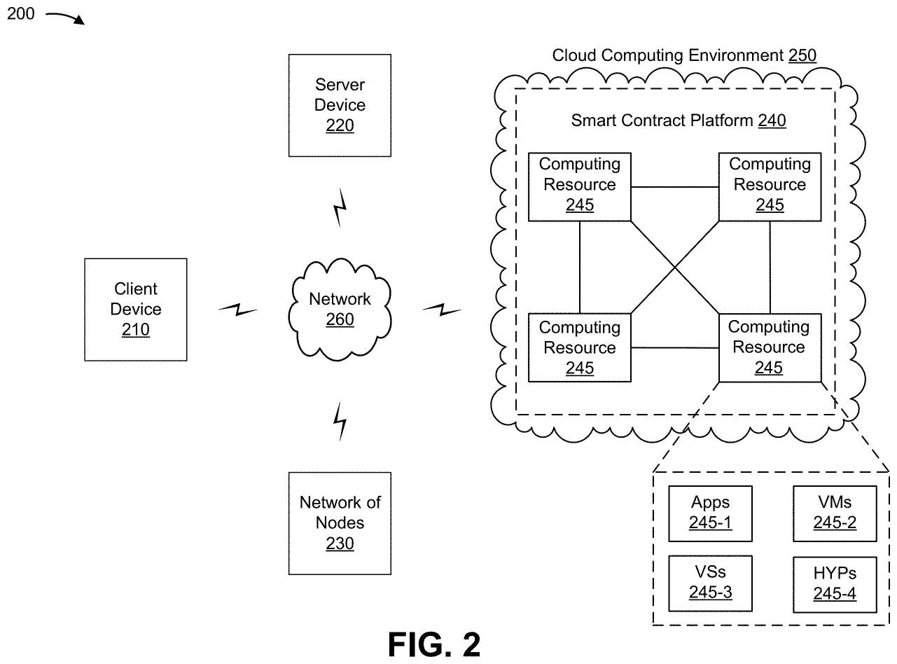

FIG. 2 is a diagram of an example environment 200 in which systems and/or methods, described herein, may be implemented. As shown in FIG. 2, environment 200 may include a client device 210, a server device 220, a network of nodes 230, a smart contract platform 240 having at least one computing resource 245, a cloud computing environment 250, and a network 260. Devices of environment 200 may interconnect via wired connections, wireless connections, or a combination of wired and wireless connections.

Client device 210 includes one or more devices capable of receiving, generating, storing, processing, and/or providing information associated with a request to generate a smart contract and/or making selections relating to a smart contract. For example, client device 210 may include a communication and/or computing device, such as a mobile phone (e.g., a smart phone, a radiotelephone, etc.), a laptop computer, a tablet computer, a handheld computer, a desktop computer, a gaming device, a wearable communication device (e.g., a smart wristwatch, a pair of smart eyeglasses, etc.), or a similar type of device.

Server device 220 includes one or more devices capable of storing, processing, and/or routing information associated with one or more code snippets. In some implementations, server device 220 may include a communication interface that allows server device 220 to receive information from and/or transmit information to other devices in environment 200.

Network of nodes 230 may be part of a network that is able to utilize a distributed ledger and/or smart contract platform 240 to store smart contracts and/or perform actions defined in the smart contracts, as described herein. In some implementations, network of nodes 230 may provide a blockchain for storing smart contracts, code snippets for smart contracts, hashes for code snippets, quality indications for code snippets, one or more catalogues of code snippets, and/or the like.

One or more nodes in the network of nodes 230 include one or more devices capable of receiving, generating, storing, processing, and/or providing information associated with a contract and/or smart contract. For example, one or more nodes of the network of nodes 230 may include a computing device (e.g., a desktop computer, a laptop computer, a tablet computer, a handheld computer, a server device, etc.), a mobile phone (e.g., a smart phone, a radiotelephone, etc.), or a similar device. In some implementations, one or more nodes of the network of nodes 230 may be a device associated with an entity, such as an organization, a subsidiary of the organization, an individual, and/or the like. In some implementations, one or more nodes of the network of nodes 230 may be associated with multiple organizations, multiple subsidiaries of an organization, multiple individuals, and/or the like.

Smart contract platform 240 includes one or more computing resources configured to generate a smart contract. For example, smart contract platform 240 may be a platform implemented by cloud computing environment 250 that may generate a smart contract. In some implementations, smart contract platform 240 is implemented by computing resources 245 of cloud computing environment 250.

Smart contract platform 240 includes one or more devices capable of receiving, generating, storing, processing, and/or providing information associated generating a smart contract using one or more code snippets. For example, smart contract platform 240 may include a server device (e.g., a host server, a web server, an application server, etc.), a data center device, or a similar device.

Cloud computing environment 250 includes an environment that delivers computing as a service, whereby shared resources, services, etc. may be provided to smart contract platform 240. Cloud computing environment 250 may provide computation, software, data access, storage, and/or other services that do not require end-user knowledge of a physical location and configuration of a system and/or a device that delivers the services. As shown, cloud computing environment 250 may include a smart contract platform 240 and a computing resource 245.

Computing resource 245 includes one or more personal computers, workstation computers, server devices, or another type of computation and/or communication device. In some implementations, computing resource 245 may host smart contract platform 240. The cloud resources may include compute instances executing in computing resource 245, storage devices provided in computing resource 245, data transfer devices provided by computing resource 245, etc. In some implementations, computing resource 245 may communicate with other computing resources 245 via wired connections, wireless connections, or a combination of wired and wireless connections.

As further shown in FIG. 2, computing resource 245 may include a group of cloud resources, such as one or more applications (“APPs”) 245-1, one or more virtual machines (“VMs”) 245-2, virtualized storage (“VSs”) 245-3, one or more hypervisors (“HYPs”) 245-4, or the like.

Application 245-1 includes one or more software applications that may be provided to or accessed by client device 210. Application 245-1 may eliminate a need to install and execute the software applications on client device 210. For example, application 245-1 may include software associated with smart contract platform 240 and/or any other software capable of being provided via cloud computing environment 250. In some implementations, one application 245-1 may send/receive information to/from one or more other applications 245-1, via virtual machine 245-2.

Virtual machine 245-2 includes a software implementation of a machine (e.g., a computer) that executes programs like a physical machine. Virtual machine 245-2 may be either a system virtual machine or a process virtual machine, depending upon use and degree of correspondence to any real machine by virtual machine 245-2. A system virtual machine may provide a complete system platform that supports execution of a complete operating system (“OS”). A process virtual machine may execute a single program and may support a single process. In some implementations, virtual machine 245-2 may execute on behalf of a user (e.g., client device 210), and may manage infrastructure of cloud computing environment 250, such as data management, synchronization, or long-duration data transfers.

Virtualized storage 245-3 includes one or more storage systems and/or one or more devices that use virtualization techniques within the storage systems or devices of computing resource 245. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 245-4 provides hardware virtualization techniques that allow multiple operating systems (e.g., “guest operating systems”) to execute concurrently on a host computer, such as computing resource 245. Hypervisor 245-4 may present a virtual operating platform to the guest operating systems and may manage the execution of the guest operating systems. Multiple instances of a variety of operating systems may share virtualized hardware resources.

Network 260 includes one or more wired and/or wireless networks. For example, network 260 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

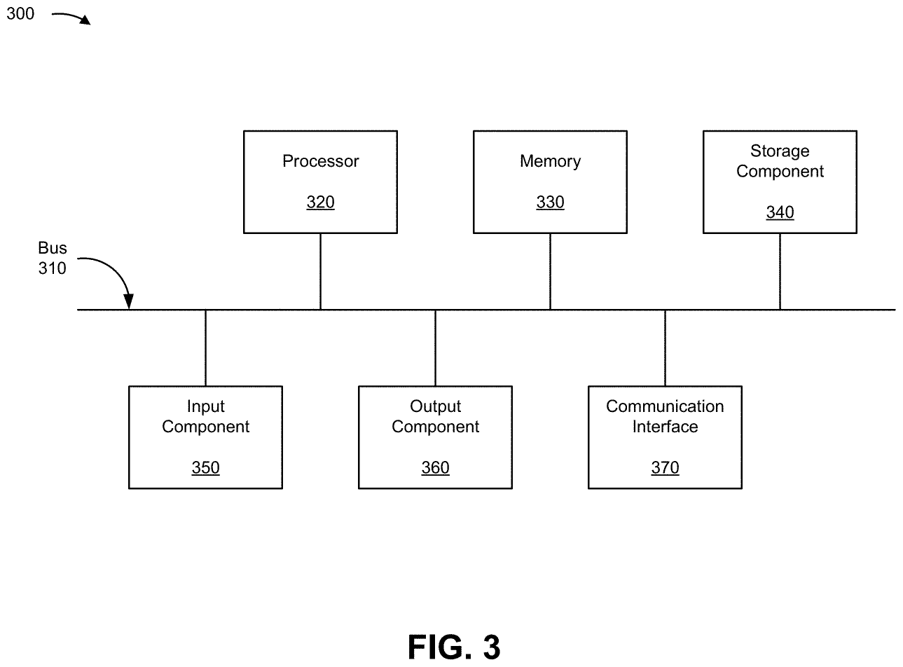

FIG. 3 is a diagram of example components of a device 300. Device 300 may correspond to client device 210, server device 220, one or more nodes of the network of nodes 230, smart contract platform 240, and/or a computing resource 245. In some implementations, client device 210, server device 220, one or more nodes of the network of nodes 230, smart contract platform 240, and/or a computing resource 245 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among multiple components of device 300. Processor 320 is implemented in hardware, firmware, and/or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a component for determining location (e.g., a global positioning system (GPS) component) and/or a sensor (e.g., an accelerometer, a gyroscope, an actuator, another type of positional or environmental sensor, and/or the like). Output component 360 includes a component that provides output information from device 300 (via, e.g., a display, a speaker, a haptic feedback component, an audio or visual indicator, and/or the like).

Communication interface 370 includes a transceiver-like component (e.g., a transceiver, a separate receiver, a separate transmitter, and/or the like) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. As used herein, the term “computer-readable medium” refers to a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

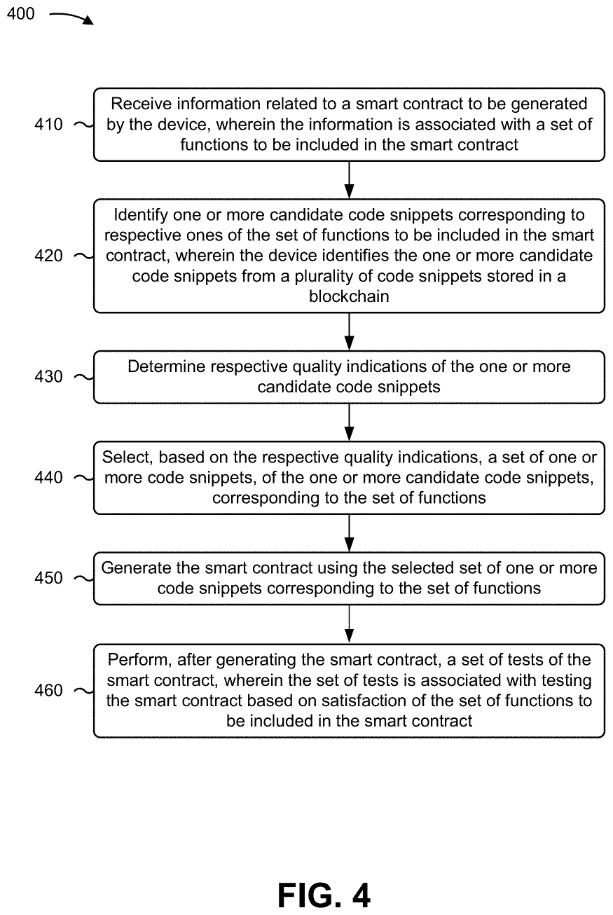

FIG. 4 is a flow chart of an example process 400 for generating a smart contract. In some implementations, one or more process blocks of FIG. 4 may be performed by a device (e.g., smart contract platform 240). In some implementations, one or more process blocks of FIG. 4 may be performed by another device or a group of devices separate from or including the device, such as a client device (e.g., client device 210), a server device (e.g., server device 220), a network of nodes (e.g., network of nodes 230), and/or the like.

As shown in FIG. 4, process 400 may include receiving information related to a smart contract to be generated by the device, wherein the information is associated with a set of functions to be included in the smart contract (block 410). For example, the device (e.g., using computing resource 245, processor 320, memory 330, storage component 340, input component 350, output component 360, communication interface 370 and/or the like) may receive information related to a smart contract to be generated by the device, as described above. In some implementations, the information may be associated with a set of functions to be included in the smart contract.

As further shown in FIG. 4, process 400 may include identifying one or more candidate code snippets corresponding to respective ones of the set of functions to be included in the smart contract, wherein the device identifies the one or more candidate code snippets from a plurality of code snippets stored in a blockchain (block 420). For example, the device (e.g., using computing resource 245, processor 320, memory 330, storage component 340, input component 350, output component 360, communication interface 370 and/or the like) may identify one or more candidate code snippets corresponding to respective ones of the set of functions to be included in the smart contract, as described above. In some implementations, the device may identify the one or more candidate code snippets from a plurality of code snippets stored in a blockchain, as described above.

As further shown in FIG. 4, process 400 may include determining respective quality indications of the one or more candidate code snippets (block 430). For example, the device (e.g., using computing resource 245, processor 320, memory 330, storage component 340, input component 350, output component 360, communication interface 370 and/or the like) may determine respective quality indications of the one or more candidate code snippets, as described above.

As further shown in FIG. 4, process 400 may include selecting, based on the respective quality indications, a set of one or more code snippets, of the one or more candidate code snippets, corresponding to the set of functions (block 440). For example, the device (e.g., using computing resource 245, processor 320, memory 330, storage component 340, input component 350, output component 360, communication interface 370 and/or the like) may select, based on the respective quality indications, a set of one or more code snippets, of the one or more candidate code snippets, corresponding to the set of functions, as described above.

As further shown in FIG. 4, process 400 may include generating the smart contract using the selected set of one or more code snippets corresponding to the set of functions (block 450). For example, the device (e.g., using computing resource 245, processor 320, memory 330, storage component 340, input component 350, output component 360, communication interface 370 and/or the like) may generate the smart contract using the selected set of one or more code snippets corresponding to the set of functions, as described above.

As further shown in FIG. 4, process 400 may include performing, after generating the smart contract, a set of tests of the smart contract, wherein the set of tests is associated with testing the smart contract based on satisfaction of the set of functions to be included in the smart contract (block 460). For example, the device (e.g., using computing resource 245, processor 320, memory 330, storage component 340, input component 350, output component 360, communication interface 370 and/or the like) may perform, after generating the smart contract, a set of tests of the smart contract, as described above. In some implementations, the set of tests may be associated with testing the smart contract based on satisfaction of the set of functions to be included in the smart contract, as described above.

Process 400 may include additional implementations, such as any single implementation or any combination of implementations described below and/or in connection with one or more other processes described elsewhere herein.

In a first implementation, process 400 further comprises associating, using a machine learning process, the information with the set of functions to be included in the smart contract.

In a second implementation, alone or in combination with the first implementation, process 400 further comprises verifying authenticity of the one or more candidate code snippets, wherein verifying the authenticity of the one or more candidate code snippets includes comparing respective first hashes of the one or more candidate code snippets with respective second hashes of authentic code snippets, and selecting the set of one or more code snippets, of the one or more candidate code snippets, is further based on results of verifying the authenticity of the one or more candidate code snippets.

In a third implementation, alone or in combination with one or more of the first and second implementations, process 400 further comprises selecting one or more replacement code snippets, for one or more code snippets of the selected set of one or more candidate code snippets, based on a result of one or more tests of the set of tests of the smart contract.

In a fourth implementation, alone or in combination with one or more of the first through third implementations, process 400 further comprises combining the set of one or more code snippets into a code document in an order in which the set of one or more code snippets is to be executed upon satisfaction of one or more conditions and including, in association with combining the set of one or more code snippets into the code document, wrapper code in the code document.

In a fifth implementation, alone or in combination with one or more of the first through fourth implementations, a respective quality indication, of the respective quality indications, includes information regarding one or more of a respective indication of a source of one of the one or more candidate code snippets, a respective indication of a quantity of other smart contracts using the one of the one or more candidate code snippets, or a respective quality rating of the one of the one or more candidate code snippets based on prior or current use of the one of the one or more candidate code snippets.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

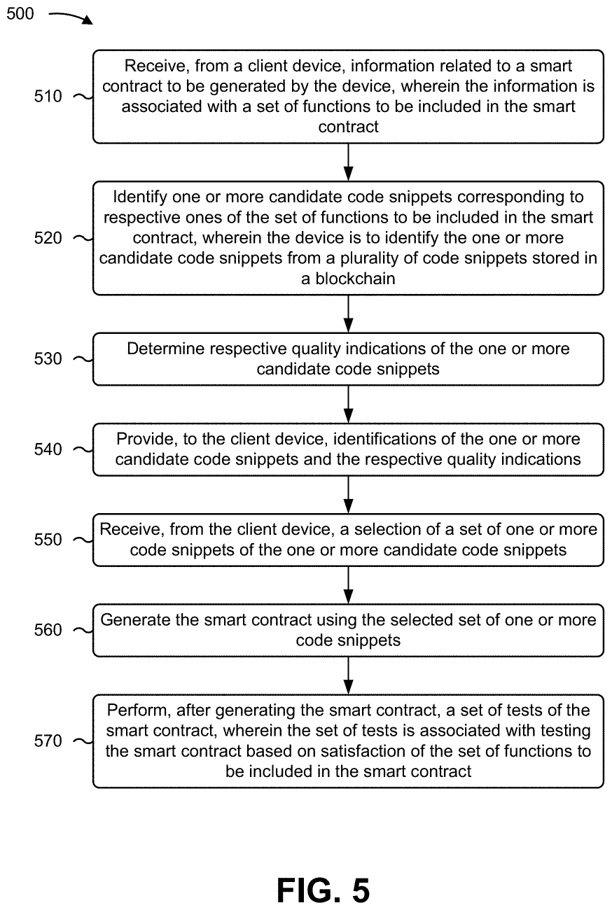

FIG. 5 is a flow chart of an example process 500 for generating a smart contract. In some implementations, one or more process blocks of FIG. 5 may be performed by a device (e.g., smart contract platform 240). In some implementations, one or more process blocks of FIG. 5 may be performed by another device or a group of devices separate from or including the device, such as a client device (e.g., client device 210), a server device (e.g., server device 220), a network of nodes (e.g., network of nodes 230), and/or the like.

As shown in FIG. 5, process 500 may include receiving, from a client device, information related to a smart contract to be generated by the device, wherein the information is associated with a set of functions to be included in the smart contract (block 510). For example, the device (e.g., using computing resource 245, processor 320, memory 330, storage component 340, input component 350, output component 360, communication interface 370 and/or the like) may receive, from a client device, information related to a smart contract to be generated by the device, as described above. In some implementations, the information may be associated with a set of functions to be included in the smart contract.

As further shown in FIG. 5, process 500 may include identifying one or more candidate code snippets corresponding to respective ones of the set of functions to be included in the smart contract, wherein the device is to identify the one or more candidate code snippets from a plurality of code snippets stored in a blockchain (block 520). For example, the device (e.g., using computing resource 245, processor 320, memory 330, storage component 340, input component 350, output component 360, communication interface 370 and/or the like) may identify one or more candidate code snippets corresponding to respective ones of the set of functions to be included in the smart contract, as described above. In some implementations, the device may identify the one or more candidate code snippets from a plurality of code snippets stored in a blockchain.

As further shown in FIG. 5, process 500 may include determining respective quality indications of the one or more candidate code snippets (block 530). For example, the device (e.g., using computing resource 245, processor 320, memory 330, storage component 340, input component 350, output component 360, communication interface 370 and/or the like) may determine respective quality indications of the one or more candidate code snippets, as described above.

As further shown in FIG. 5, process 500 may include providing, to the client device, identifications of the one or more candidate code snippets and the respective quality indications (block 540). For example, the device (e.g., using computing resource 245, processor 320, memory 330, storage component 340, input component 350, output component 360, communication interface 370 and/or the like) may provide, to the client device, identifications of the one or more candidate code snippets and the respective quality indications, as described above.

As further shown in FIG. 5, process 500 may include receiving, from the client device, a selection of a set of one or more code snippets of the one or more candidate code snippets (block 550). For example, the device (e.g., using computing resource 245, processor 320, memory 330, storage component 340, input component 350, output component 360, communication interface 370 and/or the like) may receive, from the client device, a selection of a set of one or more code snippets of the one or more candidate code snippets, as described above.

As further shown in FIG. 5, process 500 may include generating the smart contract using the selected set of one or more code snippets (block 560). For example, the device (e.g., using computing resource 245, processor 320, memory 330, storage component 340, input component 350, output component 360, communication interface 370 and/or the like) may generate the smart contract using the selected set of one or more code snippets, as described above.

As further shown in FIG. 5, process 500 may include performing, after generating the smart contract, a set of tests of the smart contract, wherein the set of tests is associated with testing the smart contract based on satisfaction of the set of functions to be included in the smart contract (block 570). For example, the device (e.g., using computing resource 245, processor 320, memory 330, storage component 340, input component 350, output component 360, communication interface 370 and/or the like) may perform, after generating the smart contract, a set of tests of the smart contract, as described herein. In some implementations, the set of tests may be associated with testing the smart contract based on satisfaction of the set of functions to be included in the smart contract, as described above.

Process 500 may include additional implementations, such as any single implementation or any combination of implementations described below and/or in connection with one or more other processes described elsewhere herein.

In a first implementation, process 500 further includes associating the information with the set of functions to be included in the smart contract.

In a second implementation, alone or in combination with the first implementation, the process 500 further includes providing, prior to receiving the information, a set of descriptions corresponding to a set of candidate functions, including the set of functions to be included in the smart contract, for display via a client device.

In a third implementation, alone or in combination with one or more of the first and second implementations, process 500 further includes providing, to the client device and based on a result of one or more tests of the smart contract, identifications of one or more replacement code snippets, receive, from the client device, a selection of replacement code snippets, and replace, in the smart contract, one or more code snippets of the selected set of one or more code snippets with one or more of the selected replacement code snippets.

In a fourth implementation, alone or in combination with one or more of the first through third implementations, the set of functions includes at least one function corresponding to one or more of a first trigger to initiate a payment, a second trigger to initiate sending, to another device, a command to perform a task, an identity of one or more parties to the smart contract, or a transaction account identifier.

In a fifth implementation, in combination with the fourth implementation, the first trigger or the second trigger includes one or both of satisfaction of a timing condition or satisfaction of a performance condition.

In a sixth implementation, alone or in combination with one or more of the first through fifth implementations, process 500 further includes detecting satisfaction of one or more conditions associated with the smart contract, and perform, based on the satisfaction of the one or more conditions, one or more actions defined by the smart contract.

In a seventh implementation, alone or in combination with one or more of the first through sixth implementations, a respective quality indication, of the respective quality indications, includes information regarding one or more of a respective source of one of the one or more candidate code snippets, a respective indication of a quantity of other smart contracts using the one of the one or more candidate code snippets, or a respective quality rating of the one of the one or more candidate code snippets based on prior or current use of the one of the one or more candidate code snippets.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

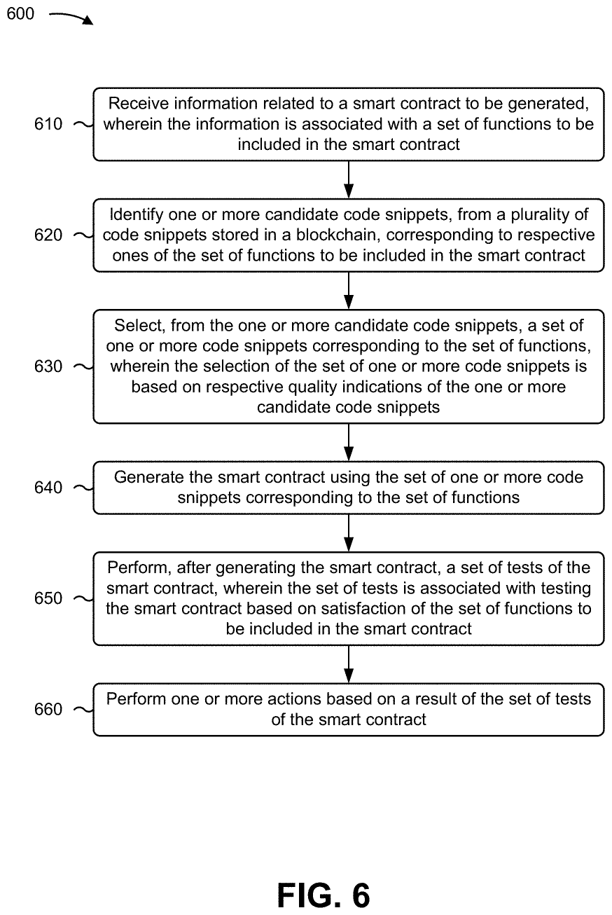

FIG. 6 is a flow chart of an example process 600 for generating a smart contract. In some implementations, one or more process blocks of FIG. 6 may be performed by a device (e.g., smart contract platform 240). In some implementations, one or more process blocks of FIG. 6 may be performed by another device or a group of devices separate from or including the device, such as a client device (e.g., client device 210), a server device (e.g., server device 220), a network of nodes (e.g., network of nodes 230), and/or the like.

As shown in FIG. 6, process 600 may include receiving information related to a smart contract to be generated, wherein the information is associated with a set of functions to be included in the smart contract (block 610). For example, the device (e.g., using computing resource 245, processor 320, memory 330, storage component 340, input component 350, output component 360, communication interface 370 and/or the like) may receive information related to a smart contract to be generated, as described above. In some implementations, the information is associated with a set of functions to be included in the smart contract.

As further shown in FIG. 6, process 600 may include identifying one or more candidate code snippets, from a plurality of code snippets stored in a blockchain, corresponding to respective ones of the set of functions to be included in the smart contract (block 620). For example, the device (e.g., using computing resource 245, processor 320, memory 330, storage component 340, input component 350, output component 360, communication interface 370 and/or the like) may identify one or more candidate code snippets, from a plurality of code snippets stored in a blockchain, corresponding to respective ones of the set of functions to be included in the smart contract, as described above.

As further shown in FIG. 6, process 600 may include selecting, from the one or more candidate code snippets, a set of one or more code snippets corresponding to the set of functions, wherein the selection of the set of one or more code snippets is based on respective quality indications of the one or more candidate code snippets (block 630). For example, the device (e.g., using computing resource 245, processor 320, memory 330, storage component 340, input component 350, output component 360, communication interface 370 and/or the like) may select, from the one or more candidate code snippets, a set of one or more code snippets corresponding to the set of functions, as described above. In some implementations, the selection of the set of one or more code snippets may be based on respective quality indications of the one or more candidate code snippets, as described above.

As further shown in FIG. 6, process 600 may include generating the smart contract using the set of one or more code snippets corresponding to the set of functions (block 640). For example, the device (e.g., using computing resource 245, processor 320, memory 330, storage component 340, input component 350, output component 360, communication interface 370 and/or the like) may generate the smart contract using the set of one or more code snippets corresponding to the set of functions, as described above.

As further shown in FIG. 6, process 600 may include performing, after generating the smart contract, a set of tests of the smart contract, wherein the set of tests is associated with testing the smart contract based on satisfaction of the set of functions to be included in the smart contract (block 650). For example, the device (e.g., using computing resource 245, processor 320, memory 330, storage component 340, input component 350, output component 360, communication interface 370 and/or the like) may perform, after generating the smart contract, a set of tests of the smart contract, as described above. In some implementations, the set of tests may be associated with testing the smart contract based on satisfaction of the set of functions to be included in the smart contract, as described above.

As further shown in FIG. 6, process 600 may include performing one or more actions based on a result of the set of tests of the smart contract (block 660). For example, the device (e.g., using computing resource 245, processor 320, memory 330, storage component 340, input component 350, output component 360, communication interface 370 and/or the like) may perform one or more actions based on a result of the set of tests of the smart contract, as described above.

Process 600 may include additional implementations, such as any single implementation or any combination of implementations described below and/or in connection with one or more other processes described elsewhere herein.

In a first implementation, to process 600 further includes selecting one or more replacement code snippets, for one or more code snippets of the set of one or more code snippets, based on a result of one or more of the set of tests of the smart contract, store the smart contract in the blockchain, or determine one or more causes of the result of the set of tests of the smart contract.

In a second implementation, alone or in combination with the first implementation, process 600 further includes combining the set of one or more code snippets into a code document in an order in which the set of one or more code snippets is to be executed upon satisfaction of one or more conditions and include, in association with combining the set of one or more code snippets into the code document, wrapper code in the code document.

In a third implementation, alone or in combination with one or more of the first and second implementations, the set of functions includes at least one function corresponding to one or more of a first trigger to initiate a payment, a second trigger to initiate sending, to another device, a command to perform a task, an identity of one or more parties to the smart contract, or a transaction account identifier.

In a fourth implementation, alone or in combination with one or more of the first through third implementations, process 600 further includes detecting satisfaction of one or more conditions associated with the smart contract and perform, based on the satisfaction of the one or more conditions, one or more actions defined by the smart contract.

In a fifth implementation, alone or in combination with one or more of the first through fourth implementations, a respective quality indication, of the respective quality indications, includes information regarding one or more of a respective source of one of the one or more candidate code snippets, a respective indication of a quantity of other smart contracts using the one of the one or more candidate code snippets, or a respective quality rating of the one of the one or more candidate code snippets based on prior or current use of the one of the one or more candidate code snippets.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, or a combination of hardware and software.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, and/or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method, comprising:
receiving, by a device, information associated with generating a smart contract;
generating, by the device, an information scanning model to identify a description of a function to be included in the smart contract;
determining, by the device, and using the information scanning model, a set of functions associated with the received information based on a threshold probability,
the set of functions including at least one function corresponding to a trigger to initiate a payment;
identifying, by the device, a plurality of candidate code snippets corresponding to respective ones of the set of functions associated with the smart contract,
wherein the device identifies the plurality of candidate code snippets from a plurality of code snippets stored in a blockchain;
determining, by the device, respective quality indications of the plurality of candidate code snippets;
selecting, by the device and based on the respective quality indications, a set of code snippets, of the plurality of candidate code snippets, corresponding to the set of functions,
wherein a quality indication, of the respective quality indications, includes information regarding a respective indication of a quantity of other smart contracts using one of the plurality of candidate code snippets;
generating, by the device, the smart contract using the selected set of code snippets corresponding to the set of functions,
where the generating the smart contract comprises:
combining the set of code snippets into a code document, and
including, in the code document, wrapper code with the set of code snippets,
the wrapper code providing one or more interfaces between individual code snippets of the set of code snippets;
performing, by the device and after generating the smart contract, a set of tests of the smart contract to determine that the set of functions are satisfied and are included in the smart contract;
executing, by the device, code of the smart contract to perform terms of the smart contact based on one or more results of performing the set of tests;
detecting, by the device, satisfaction of a condition included in the smart contract, the condition being the trigger to initiate the payment; and
performing, by the device, one or more actions based on satisfaction of the smart contact,
wherein performing the one or more actions comprises:
initiating the payment.

2. The method of claim 1, further comprising:
determining, using a machine learning process, the information associated with the set of functions.

3. The method of claim 1, further comprising:
verifying, by the device, authenticity of the plurality of candidate code snippets,
wherein verifying the authenticity of the plurality of candidate code snippets includes comparing respective first hashes of the plurality of candidate code snippets with respective second hashes of authentic code snippets; and
wherein selecting the set of code snippets, of the plurality of candidate code snippets, is further based on results of verifying the authenticity of the plurality of candidate code snippets.

4. The method of claim 1, further comprising:
selecting, by the device, one or more replacement code snippets, for one or more code snippets of the selected set of the plurality of candidate code snippets, based on a result of one or more tests of the set of tests of the smart contract.

5. The method of claim 1, wherein combining the set of code snippets comprises:
combining the set of code snippets into the code document in an order of execution of the set of code snippets based upon satisfaction of one or more conditions.

6. The method of claim 1, wherein a respective quality indication, of the respective quality indications, includes information regarding one or more of:
a respective indication of a source of one of the plurality of candidate code snippets;
or
a respective quality rating of the one of the plurality of candidate code snippets based on prior or current use of the one of the plurality of candidate code snippets.

7.-14. (canceled)

15. A non-transitory computer-readable medium storing instructions, the instructions comprising:
one or more instructions that, when executed by one or more processors, cause the one or more processors to:
receive information associated with generating a smart contract;
generate an information scanning model to identify a description of a function to be included in the smart contract;
determine, using the information scanning model, a set of functions associated with the received information based on a threshold probability,
the set of functions including at least one function corresponding to a trigger to initiate a payment;
identify a plurality of candidate code snippets, from a plurality of code snippets stored in a blockchain, corresponding to respective ones of the set of functions associated with the smart contract;
select, from the plurality of candidate code snippets, a set of code snippets corresponding to the set of functions;
wherein the selection of the set of code snippets is based on respective quality indications of the plurality of candidate code snippets,
wherein a quality indication, of the respective quality indications, includes information regarding a respective indication of a quantity of other smart contracts using one of the plurality of candidate code snippets;
generate the smart contract using the set of code snippets corresponding to the set of functions,
where the one or more instructions, that cause the one or more processors to generate the smart contract, cause the one or more processors to:
combine the set of code snippets into a code document, and
include, in the code document, wrapper code with the set of code snippets,
the wrapper code providing one or more interfaces between individual code snippets of the set of code snippets;
perform, after generating the smart contract, a set of tests of the smart contract,
wherein the set of tests is associated with testing the smart contract based on satisfaction of the set of functions to be included in the smart contract;
execute code of the smart contract to perform terms of the smart contact based on a result of the set of tests;
detect satisfaction of a condition included in the smart contract,
the condition being the trigger to initiate the payment; and
perform one or more actions based on satisfaction of the condition,
wherein the one or more instructions, that cause the one or more processors to perform the one or more actions, cause the one or more processors to:
initiate the payment.

16. The non-transitory computer-readable medium of claim 15, wherein the one or more instructions, that cause the one or more processors to perform the one or more actions, cause the one or more processors to:
select one or more replacement code snippets, for one or more code snippets of the set of code snippets, based on a result of one or more of the set of tests of the smart contract; or
store the smart contract in the blockchain.

17. The non-transitory computer-readable medium of claim 15, wherein the one or more instructions, that cause the one or more processors to combine the set of code snippets, cause the one or more processors to:
combine the set of code snippets into the code document in an order of execution of the set of code snippets based upon satisfaction of one or more conditions.

18. The non-transitory computer-readable medium of claim 15, wherein the set of functions further includes at least one function corresponding to one or more of:
another trigger to initiate sending, to another device, a command to perform a task;
an identity of one or more parties to the smart contract; or
a transaction account identifier.

19. The non-transitory computer-readable medium of claim 15, wherein the one or more instructions, that cause the one or more processors to perform the one or more actions, cause the one or more processors to:
store the smart contract in the blockchain.

20. The non-transitory computer-readable medium of claim 15, wherein a respective quality indication, of the respective quality indications, includes information regarding one or more of:
a respective source of one of the plurality of candidate code snippets;
or
a respective quality rating of the one of the plurality of candidate code snippets based on prior or current use of the one of the plurality of candidate code snippets.

21. A device, comprising:
one or more memories; and
one or more processors, communicatively coupled to the one or more memories, configured to:
receive information associated with generating a smart contract;
generate an information scanning model to identify a description of a function to be included in the smart contract;
determine, using the information scanning model, a set of functions associated with the received information based on a threshold probability,
the set of functions including at least one function corresponding to a trigger to initiate a payment;
identify a plurality of candidate code snippets, from a plurality of code snippets stored in a blockchain, corresponding to respective ones of the set of functions to be included in the smart contract;
select, from the plurality of candidate code snippets, a set of code snippets corresponding to the set of functions;
wherein the selection of the set of code snippets is based on respective quality indications of the plurality of candidate code snippets,
wherein a quality indication, of the respective quality indications, includes information regarding a respective indication of a quantity of other smart contracts using one of the plurality of candidate code snippets;
generate the smart contract using the set of code snippets corresponding to the set of functions,
where the one or more processors, when generating the smart contract, are to:
combine the set of code snippets into a code document, and
include, in the code document, wrapper code with the set of code snippets,
the wrapper code providing one or more interfaces between individual code snippets of the set of code snippets;
perform, after generating the smart contract, a set of tests of the smart contract,
wherein the set of tests is associated with testing the smart contract based on satisfaction of the set of functions to be included in the smart contract;
execute code of the smart contract to perform terms of the smart contact based on a result of the set of tests;
detect satisfaction of a condition included in the smart contract,
the condition being the trigger to initiate the payment; and
perform one or more actions based on satisfaction of the condition,
wherein the one or more processors, when performing the one or more actions, are to:
initiate the payment.

22. The device of claim 21, wherein the one or more processors are further configured to:
determine, using a machine learning process, the information associated with the set of functions.

23. The device of claim 21, wherein the one or more processors are further configured to:
select one or more replacement code snippets, for one or more code snippets of the selected set of a plurality of candidate code snippets, based on a result of one or more tests of the set of tests of the smart contract.

24. The device of claim 21, wherein the one or more processors, when combining the set of code snippets, are to:
combine the set of code snippets into the code document in an order of execution of the set of code snippets based upon satisfaction of one or more conditions.

25. The device of claim 21, wherein the set of functions further includes at least one function corresponding to one or more of:
another trigger to initiate sending, to another device, a command to perform a task,
an identity of one or more parties to the smart contract, or
a transaction account identifier.

26. The device of claim 25, wherein the other trigger includes one or both of satisfaction of a timing condition or satisfaction of a performance condition.

27. The device of claim 21, wherein the one or more processors are further configured to:
determine that one or more conditions associated with the smart contract are satisfied; and perform, based on the satisfaction of the one or more conditions, one or more of:
store the smart contract in the blockchain, or
determine one or more causes of the result of the set of tests of the smart contract.

28. The device of claim 21, wherein a respective quality indication, of the respective quality indications, includes information regarding one or more of:
a respective indication of a source of one of the plurality of candidate code snippets;
or
a respective quality rating of the one of the plurality of candidate code snippets based on prior or current use of the one of the plurality of candidate code snippets.
